(19) United States
(12) Patent Application Publication
(10) Pub. No.: US 2014/0014868 A1
(43) Pub. Date: Jan. 16, 2014

(54) COCK FITTING

(71) Applicant: Phonix Armaturen-Werke Bregel GmbH, Volkmarsen (DE)

(72) Inventors: Gunter Wodara, Bad Arolsen (DE); Rainer Becker, Hennef (DE); Berthold Jager, Leinefelde (DE); Hannes Kellermann, Kassel (DE)

(21) Appl. No.: 13/915,977

(22) Filed: Jun. 12, 2013

(30) Foreign Application Priority Data
Jul. 13, 2012 (EP) EP12005157.8

(51) Int. Cl. F16K 5/08

(52) U.S. Cl. CPC F16K 5/08
USPC 251/318

(57) ABSTRACT

A cock fitting includes a cock plug disposed in a housing. The cock plug is connected to a drive arrangement for lifting and subsequent rotation of the cock plug, wherein the drive arrangement is configured to operate hydraulically for lifting as well as for rotating the cock plug.

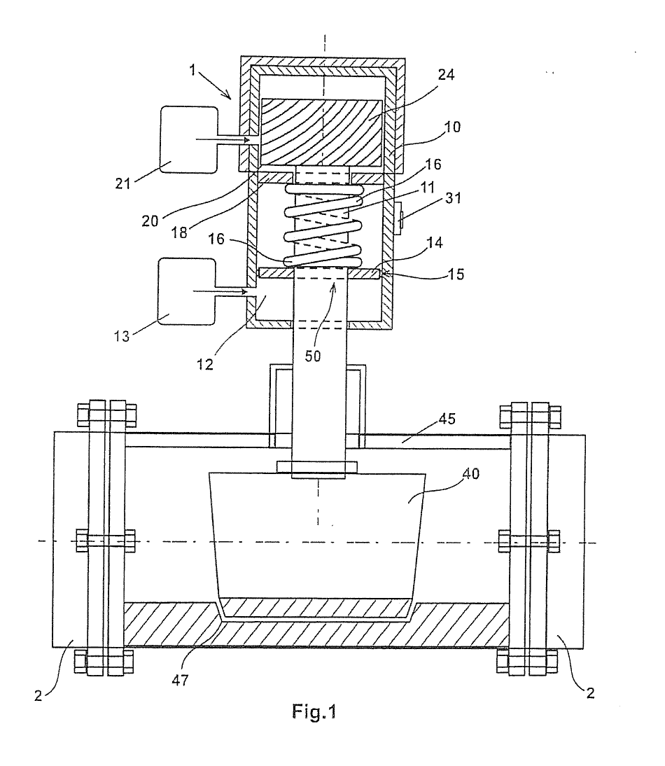

### CROSS REFERENCE TO RELATED APPLICATION

This application claims priority from European patent application No. 12 005 157.8, filed Jul. 13, 2012, the entire content of which is incorporated herein by reference.

### FIELD OF THE INVENTION

The invention relates to a cock fitting comprising a cock plug disposed in a housing, wherein the cock plug is connected to a drive arrangement for lifting and subsequent rotation of the cock plug.

### BACKGROUND OF THE INVENTION

A cock fitting of the type mentioned in the introduction is known from the prior art. Such a cock fitting, also configured as a tap cock or as a cock switch-over device, is used in places in which closing or switching a pipe must occur in an extremely reliable manner under great forces and high thermal stresses. As explained, the known tap cocks or cock switch-over devices are used to this end.

A known tap cock is characterized in that, in the housing, the cock plug is first pulled out of its seat by a spindle, then turned and then lowered again. The advantage of this procedure is that even with high forces, wear is minimal. A cock switch-over device operates in a similar manner; here also the cock plug is first axially lifted out of the original seat, then turned and then lowered again.

In big cock fittings, in which more exactness and precision during lifting and rotation are important, the use of so-called ball screw transmissions is known. The cock plug is first lifted by way of the ball screw transmission, wherein in the upper final position, a further axial movement is blocked by a ball of the ball screw transmission, and the force acting onto the ball screw transmission leads to a rotation of the cock plug. After a rotation of approximately 90°, the ball falls out of the ball lock, the cock plug can be lowered again and the procedure can begin anew. A disadvantage of this known prior art, is that the balls operate under high thermal stress variations and high mechanical strain. The operational security of such a tap cock is then no longer ensured.

### SUMMARY OF THE INVENTION

Therefore, the object underlying the invention is to provide a cock fitting of the type mentioned in the introduction, which operates without wear and in an extremely reliable manner over a long period of time, independently of its constructional size and independently of high thermal stress and more specifically also independently of great thermal stress variations.

In order to solve the object, it is proposed according to the invention, that the drive device for lifting as well as rotating the cock plug is configured so that it operates hydraulically.

It has already been pointed out that a cock fitting is characterized in that the cock plug is not rotated in the seat but is first lifted out of the seat of the fitting, is then rotated in the free state and subsequently lowered back into the seat in the rotated state. The hydraulically operating drive device now ensures that the cock plug is lifted and is rotated in the second step by this hydraulically operating device. This means that the pressure for lifting the cock plug is also maintained during the rotation of the cock plug.

In detail, it is provided that the drive device has a so-called control housing with an axially displaceable and rotatable shaft inside the control housing. The cock plug is located on the end of the shaft. The shaft protrudes with the cock plug into the pipe. This also means that the axial movement of the cock plug as well as the rotational movement of the cock plug occurs by way of the axial movement of the shaft and the rotation of the shaft.

According to another feature of the invention, the shaft is loaded by a pressure spring in the axial direction of the shaft. From this, it is clear that the shaft and thus the cock plug are first lifted against the force of the pressure spring in order to be then rotated in this state. After the rotation, the cock plug is pressed into the seat in the pipe due to the force of the pressure spring. This means that the cock fitting comes with a relatively high security due to the mechanical pressure spring, since the cock plug always definitely gets back into the seat due to the pre-tensioned pressures spring, even if the hydraulic system should fail.

According to a particularly advantageous feature, it is provided that the control housing forms a first chamber, wherein the shaft is mounted in the first chamber, wherein the shaft in the chamber has a working surface, wherein the chamber is chargeable with a fluid, wherein by charging the chamber with a fluid, the shaft is displaced axially against the force of the pressure spring, wherein in the axially displaced state of the shaft, the shaft is rotatable by a value of approximately 90° by way of a hydraulically operating rotating device.

The rotating device comprises a paddle wheel disposed on the shaft, which is set into rotating motion by the fluid. Hereby, the paddle wheel is located in another chamber of the control housing. Limit switches are respectively provided for the axial movement of the shaft and the rotation of the shaft. This means that when the cock plug is lifted out of the seat in the fitting, a limit switch is activated after running along a predetermined stroke, wherein the rotational movement is then initiated, wherein the cock plug is then set down again after a rotation of approximately 90°.

### DETAILED DESCRIPTION OF THE INVENTION

In the following, the invention is exemplarily explained in more detail based on the drawing.

The cock fitting 1 is disposed in the pipe 2. The cock fitting 1 comprises a so-called control housing 10, wherein the control housing 10 receives a shaft 11 in an axially displaceable and rotatable manner In this context, the shaft has a circumferential collar 14 in the area of the first chamber 12, which is supplied by a hydraulic pump 13. Above the collar, which is disposed on the shaft 11, there is a pressure spring 16. This pressure spring 16 is mounted on a circumferential protrusion 18 disposed on the wall of the housing 10. Another second chamber 20 is provided above the protrusion 18, wherein the chamber 20 is also supplied by a hydraulic pump 21. The second chamber 20, the hydraulic pump 21, and the paddle wheel 24 form a rotating device. Furthermore, a limit switch 31 is located above the collar 14 in the housing, wherein a second limit switch, which is activated after a rotation of the paddle wheel 24 by 90°, is not shown in the drawing.

The cock plug 40 is located at the bottom end of the shaft 11. The cock plug is received in an axially displaceable and rotatable manner in the housing of the fitting located in the pipe 2. The housing itself is labeled 45, the seat in the housing 45 for the cock plug has the reference number 47. The operating mode of the cock fitting is such that the chamber 12 is first pressurized by the hydraulic pump 13, for example by pressing oil under pressure into this chamber. The oil pressure acts onto the surface of the collar 14, so that the shaft is displaced in the direction of the arrow 50. The stroke corresponds to the distance between the limit switch 31 and the collar 14 in the figure. Once the collar 14 has reached the switch 31 and the pressure spring 16 is consequently pre-tensioned against the projection 18, the hydraulic pump 21 is activated, which introduces a hydraulic fluid into the second chamber 20. The paddle wheel 24 is located on the shaft 11. The paddle wheel 24 is rotated by the hydraulic fluid. After a rotational movement of approximately 90°, the first chamber 12 is relieved of the pressure of the hydraulic fluid that was applied by the hydraulic pump 13, so that due to the pre-tension of the pressure spring 16, the cock plug is lowered downward. In this respect, the cock plug hereby gets back into its seat 47.

### REFERENCE NUMBER

1 cock fitting
2 pipe
10 control housing
11 shaft
12 first chamber
13 hydraulic pump
14 circumferential collar
16 pressure spring
18 protrusion
18 projection
20 second chamber
21 hydraulic pump
24 paddle wheel
27 rotating device
31 limit switch
40 cock plug
45 housing
47 seat
50 arrow

1-6. (canceled)

7. A cock fitting, comprising:
a plug housing;
a cock plug disposed in the plug housing;
a drive arrangement connected to the cock plug, the drive arrangement operable to lift and subsequently rotate the cock plug;
wherein the drive arrangement hydraulically lifts and hydraulically rotates the cock plug.

8. A cock fitting in accordance with claim 7, wherein:
the drive arrangement including a control housing and a shaft mounted in the housing so as to be axially displaceable and rotatable.

9. A cock fitting in accordance with claim 8, further comprising:
a pressure spring applying a load to the shaft in the axial direction of the shaft.

10. A cock fitting in accordance with claim 8, wherein:
the control housing has a first chamber defined therein;
the shaft has a working surface disposed in the chamber;
the chamber being charged with a fluid, whereby the shaft is displaced axially against the force of the pressure spring;
the fitting further including a hydraulically operating rotating device; and
wherein when the shaft is axially displaced, the shaft is rotatable by the rotating device.

11. A cock fitting in accordance with claim 10, wherein:
the rotating device comprises a paddle wheel disposed on the shaft.

12. A cock fitting in accordance with claim 11, wherein:
the control housing has a second chamber and the paddle wheel is disposed in the second chamber.
